(19) United States
(12) Patent Application Publication
(10) Pub. No.: US 2018/0157885 A1
(43) Pub. Date: Jun. 7, 2018

(54) DIGITAL IMAGE CAPTURING METHOD AND ELECTRONIC DEVICE FOR DIGITAL IMAGE CAPTURING

(71) Applicant: SULEYMAN ATAULLAH GURZUMAR, ANKARA (TR)

(72) Inventor: SULEYMAN ATAULLAH GURZUMAR, ANKARA (TR)

(21) Appl. No.: 15/567,980

(22) PCT Filed: Apr. 21, 2015
(86) PCT No.: PCT/TR2015/000164

§ 371 Date: Oct. 20, 2017

(51) Int. Cl. G06K 7/14; G06F 17/30

(52) U.S. Cl. CPC G06K 7/1447; G06K 19/06009; G06F 17/30879; G06K 7/1452

(57) ABSTRACT

An electronic device and a method are provided for digital image capturing including activating a digital camera to capture an image, when an optical code, especially a barcode is detected. Advantageously, the invention provides to zoom-out a zooming means of the digital camera before capturing the image and after detecting the optical code.

### FIELD OF INVENTION

Current invention relates to an electronic device to capture digital images and to a method for capturing digital images, especially using barcode scanning.

### BACKGROUND OF INVENTION

An optical code or specifically a barcode is an optical machine-readable representation of data relating to the object to which it is attached. Originally barcodes systematically represented data by varying the widths and spacings of parallel lines, and may be referred to as linear or one-dimensional (1D). Later they evolved into rectangles, dots, hexagons and other geometric patterns in two dimensions (2D). Although 2D systems use a variety of symbols, they are generally referred to as barcodes as well. Barcodes originally were scanned by special optical scanners called barcode readers. Later, scanners and interpretive software became available on devices including desktop printers and smartphones.

Originally designed for industrial uses, QR codes have become common in consumer advertising. Typically, a smartphone is used as a QR code scanner, displaying the code and converting it to some useful form (such as a standard URL for a website, thereby obviating the need for a user to type it into a web browser). The QR code has become a focus of advertising strategy. However, QR codes must have a very big size in order to get perceived by a digital camera or smartphone.

QR codes can be used on various mobile device operating systems. These devices support URL redirection, which allows QR codes to send metadata to existing applications on the device. Many apps are available with the ability to scan the codes and hard-link to an external URL.

Known optical code readers employing a camera detect an optical code by optical scanning with the camera and read or parse the optical code to obtain a code or an identifier, which is then provided to the user or to a digital application. However, information storage capacity of an optical code is very limited so that a digital application must retrieve additional data from a database via internet using the code or identifier.

Besides, users of such barcode readers may not necessarily remember the history of the optical codes or their contents, which have been already scanned and stored by the device.

An advanced electronic optical code detecting system is needed, which doesn't comprise the drawbacks explained above.

### SUMMARY OF THE INVENTION

Accordingly, the current invention aims to increase the amount of information obtained by an optical code reader during scanning an optical code. Accordingly, an object of the current invention is to provide an electronic device with a digital camera system configured to detect an optical code, which is able to obtain data related to the medium, where the optical code is applied, in addition to data contained in the optical code. Accordingly, an object of the current invention is to provide a support structure for such an electronic device to enable the electronic device to obtain additional data related to the medium, where the optical code is applied.

Current invention is defined by the appended claims, the content of which is included here by reference.

Current invention provides an electronic device for digital image capturing with a digital camera system comprising one or more digital cameras adapted to capture first image data, wherein the electronic device is configured to detect an optical code in first image data captured by one of the one or more digital cameras and then to activate or trigger one of the one or more digital cameras to capture second image data.

The electronic device may further comprise a digital non-volatile memory device and may be further configured to capture and store second image data automatically in the digital non-volatile memory device. The electronic device may be further configured to decode and/or to parse the optical code to obtain an identifier and second image data captured by one of the one or more digital cameras may be stored to the digital non-volatile memory device in association with the identifier.

First image data and second image data may be captured by the same digital camera or by distinct digital cameras. The electronic device may comprise a front camera at a front side thereof and a rear camera at a rear side thereof opposite to the front side and the electronic device may be configured first to capture the first image data with one of the front camera and the rear camera, and then to activate the other one of the front camera and the rear camera to capture the second image data, when an optical code in first image data is detected.

Alternatively, the electronic device may comprise a first camera with a first angle of view and a second camera with a second angle of view and the electronic device may be configured first to capture first image data with one of the first camera and the second camera to detect an optical code, and then to activate or trigger the other one of the first camera and the second camera to capture second image data, when an optical code in first image data is detected. The first camera and the second camera may be arranged such that the second angle of view (viewing field) may comprise the first angle of view at least partially.

First image data may comprise a first digital picture and/or second image data may comprise a second digital picture, preferably wherein the second digital picture may be stored in the digital non-volatile memory device in a digital computer file. Accordingly, the electronic device is configured to detect an optical code in the first image data or in the first digital picture and to trigger one of the one or more cameras to take a picture, specifically to take the second digital picture.

One or more digital cameras may be integrated to the electronic device and may be operated only and directly by the electronic device. The electronic device may comprise a microprocessor and the one or more cameras may be controllable by the microprocessor of the microprocessor.

Current invention provides also an electronic device for digital image capturing with a digital camera system comprising a digital camera adapted to capture first image data, wherein the electronic device is configured to detect an optical code in first image data captured by the digital camera and then to activate or trigger the digital camera to capture second image data. The digital camera system may comprise a zooming means. The zooming means may operate digitally and/or optically by moving a motorized configuration of lenses to change the angle of view of the first or second digital camera and/or to increase or decrease the angle of view of the first or second digital camera and/or to increase or decrease image data amount captured by the digital camera and/or to increase or decrease image detail captured by the first or second digital camera and/or to zoom-in and to zoom-out. The electronic device may be configured first to activate the zooming means, preferably by zooming in and then to capture first image data or the first digital picture, preferably such that the optical code becomes larger in the first image data or in the first digital picture, and then to activate the digital camera to capture second image data or the second digital picture, when an optical code in first image data or in the first digital picture captured by the digital camera is detected. Alternatively or additionally, the electronic device may be configured to activate the zooming means, when an optical code in first image data or in the first digital picture captured by the digital camera is detected and then to activate the digital camera to capture second image data or the second digital picture, preferably by zooming-out, preferably such that the optical code becomes smaller in the second image data or in the second digital picture. The electronic device may be configured to automatically activate the zooming means and/or the zooming amount of the zooming means may be set manually or by the optical code or the identifier. The electronic device may be configured to zoom-out before capturing image and after detecting an optical code and/or zoom-in before detecting an optical code.

According to the invention, an electronic device for digital image capturing with a digital camera system comprising a first digital camera having a first angle of view is configured to activate the first digital camera to capture an image, when an optical code in the first angle of view is detected by the electronic device.

Alternatively, the electronic device may comprise further a second digital camera with a second angle of view and the electronic device may be configured to activate the second digital camera to capture an image, when an optical code in the first angle of view is detected. The digital camera system may comprise a zooming means. The zooming means may be operated to change the first angle of view (first camera's focal length) or the second angle of view (second camera's focal length) and/or to increase or decrease the first angle of view or the second angle of view by zooming-out and zooming-in respectively. The electronic device may be configured to zoom-out before capturing image and after detecting an optical code and/or zoom-in before detecting an optical code.

The electronic device may comprise a microprocessor and the one or more cameras may be controllable by the microprocessor of the electronic device and/or the zooming means and/or the non-volatile memory may be controllable by the electronic device.

The electronic device may comprise a transmitter adapted to transmit data to internet and the electronic device may be configured to capture second image data or the second digital picture and to send or upload second image data or the second digital picture to an internet server via internet using the transmitter.

Current invention provides also an electronic device for digital image capturing with a digital camera system comprising one or more digital cameras adapted to capture image data, the electronic device further comprising one or more digital data capturing apparatus, wherein the electronic device is configured to detect an optical code in image data captured by one of the one or more digital cameras and then to activate one of the one or more digital data capturing apparatus to capture digital data. One or more digital data capturing apparatus may comprise gps, acoustic, heat and/or pressure data sensors.

Current invention provides also an electronic device for digital image capturing with a digital camera system comprising one or more digital cameras adapted to capture image data, the electronic device further comprising a digital non-volatile memory device, wherein the electronic device is configured to detect an optical code in image data captured by one of the one or more digital cameras and then to store image data captured by one of the one or more digital cameras to the digital non-volatile memory device automatically. Accordingly, the electronic device may be further configured to decode and/or to parse the optical code to obtain an identifier; and image data captured by one of the one or more digital cameras may be stored to the digital non-volatile memory device in association with the identifier.

The optical code may be a barcode. The electronic device may be a mobile device.

In order to detect an optical code, the digital camera system may scan captured image data.

Current invention provides a method for digital image capturing comprising providing an electronic device comprising a first camera with a first angle of view and a second camera with a second angle of view; capturing first image data with one of the first camera and the second camera to detect an optical code; and then automatically activating the other one of the first camera and the second camera to capture second image data, when an optical code in first image data is detected.

Current invention provides also a method for digital image capturing comprising providing an electronic device for digital image capturing with a digital camera system comprising a digital camera having a first angle of view adapted to capture first image data; capturing first image data with the digital camera to detect an optical code; and then automatically activating the digital camera to capture second image data, when an optical code in first image data is detected.

The method according to current invention may comprise automatically activating a zooming means of the digital camera system to change the first angle of view and/or to increase or decrease the first angle of view by zooming-out and zooming-in respectively. The method according to current invention may comprise zooming-out the zooming means before capturing image and/or zooming-in the zooming means to detect or to decode an optical code.

According to the invention, second image data or the second digital picture may be captured automatically, preferably after a predefined time interval.

According to the invention, activating a digital camera to capture image data may comprise to adjust the image capturing settings, preferably comprising focus, zoom rate or focal length parameter, of the digital camera automatically, preferably by retrieving predefined image capturing settings, from the optical code or from an information source using the optical code. According to the invention, activating a digital camera to capture image data may comprise to prepare the digital camera for capturing image data, preferably by executing a computer program by the electronic device.

According to the invention, the first digital picture or the second digital picture may be processed by the electronic device such that a clickable region on the first digital picture or the second digital picture is defined, which comprises the optical code image at least partially, and a url may be associated with the clickable region such that a web browser is directed to the url when the clickable region is clicked by a user.

According to the invention, one or more digital cameras and one or more digital data capturing apparatus may be integrated to the electronic device and may be operated only and directly by the electronic device. The electronic device may comprise a microprocessor and the one or more cameras and one or more digital data capturing apparatus may be controllable by the microprocessor of the electronic device.

According to the invention, zooming-in and zooming-out rate may be at least about 2×.

The electronic device may be advantageously configured to determine the size of the optical code detected in first image data or in the first digital picture and activate the zooming means depending on the size of the optical code, preferably to zoom-out or zoom-in, if the size of the optical code is larger or smaller than a predefined size respectively.

The invention may comprise advantageously to change the first angle of view such that to remove or replace or resize the optical code from or within the first angle of view.

The zooming means is operated automatically; however the zooming means may also be operated manually, i.e. the electronic device may activate or adjust the first digital camera to capture a picture and a user may trigger the electronic device to take the picture.

The second digital camera is operated automatically; however the second digital camera may also be operated manually, i.e. the electronic device may activate or adjust the second digital camera to capture a picture and a user may trigger the electronic device to take the picture.

Current invention provides also a support device for an electronic device according to the invention, comprising a docking body part adapted to support a flat surface of the electronic device having the camera at a first side of the docking body part and a protrusion protruding from the docking body part from a second side thereof opposite to the first side, such that when the electronic device is placed on the docking body part and a flat medium is approached to the camera of the electronic device for image capturing, the flat medium is obstructed by the protrusion keeping a predefined minimum distance between the camera and the medium. The protrusion may be arranged resizable. The support device enables the electronic device to keep enough distance to the medium, in order to be able to zoom-in and perceive an optical code and then to zoom-out and to capture a digital picture of the medium.

Current invention provides a computer program for digital image capturing, configured for, when executed by an electronic device for digital image capturing with a digital camera system comprising a first camera with a first angle of view and a second camera with a second angle of view; capturing first image data with one of the first camera and the second camera to detect an optical code; and then automatically activating the other one of the first camera and the second camera to capture second image data, when an optical code in first image data is detected.

Current invention provides a computer program for digital image capturing, configured for, when executed by an electronic device for digital image capturing with a digital camera system comprising a digital camera having a first angle of view adapted to capture first image data; capturing first image data with the digital camera to detect an optical code; and then automatically activating the digital camera to capture second image data, when an optical code in first image data is detected.

First image data may be retrieved or updated continuously to detect an optical image; second image data may be retrieved for once to fix a digital picture.

These and further advantages of the current invention are disclosed in the appended claims.

### SHORT EXPLANATION OF THE DRAWINGS

The above disclosed and further features of the current invention will be better understood with the following detailed description and drawings of the preferred embodiments of the invention.

FIG. 1 shows an embodiment of the electronic device according to the invention;

FIG. 2 shows a flowchart of an embodiment according to the invention; and

FIGS. 3a and 3b show an embodiment of the support device according to the invention in perspective and side views respectively.

### DETAILED EXPLANATION OF THE INVENTION

Preferred embodiments of the current invention will be described with references to the appended drawings. The dashed lines in the drawings show optional features of the preferred embodiments.

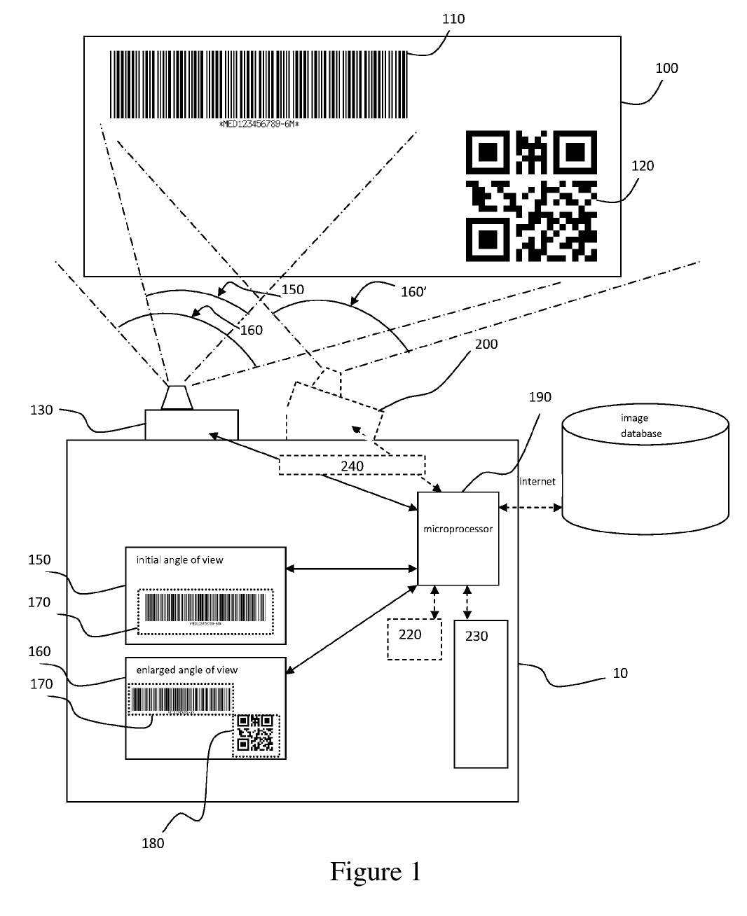

FIG. 1 shows an electronic device 10, such as a smartphone or a digital camera, according to an embodiment of the invention. The electronic device comprises a first digital camera 130 having a first angle of view 150, 160. The electronic device is configured to scan and detect optical codes, such as barcodes. In operation, a medium 100, such as an article or piece of paper, comprising an optical code 110 is provided to the electronic device for scanning the optical code. When the optical code 110 is provided to the first angle of view 150, the first digital camera 130 perceives the image of the optical code 110 and the electronic device 10 detects the optical code 110. Therefore, the electronic device 110 comprises the necessary software installed for scanning barcodes and taking pictures, as known person skilled in the art. In order to detect an optical code, the first digital camera may capture a first digital image of the first angle of view 150.

Upon detection of the optical code 110, the electronic device 10 enlarges the first angle of view 160 and then activates the first digital camera 130 to capture a picture. Alternatively or additionally, the electronic device 10 may enlarge the first angle of view 160 during or before scanning the optical code 110.

The electronic device comprises a zooming apparatus 240, which can enlarge and reduce the size of the first angle of view 150, 160. The zooming apparatus 240 is operated by the electronic device 10 digitally; however the zooming apparatus 240 may also be operated optically/mechanically and/or manually. Here, the first angle of view 160 is enlarged by zooming-out the zooming apparatus 240 by the electronic device 10. The zooming apparatus 240 is operated automatically; however the zooming apparatus 240 may also be operated manually, i.e. the electronic device 10 may activate or adjust the first digital camera 130 to capture a picture and a user may trigger the electronic device 10 to take the picture.

The electronic device 10 comprises a non-volatile memory 230. The picture taken by the first digital camera 130 is then stored in the non-volatile memory 230. Alternatively or additionally, the electronic device 10 may send the picture to an internet server via internet.

Alternatively or additionally, the electronic device 10 may comprise a second digital camera 200 with a second view of angle 160′ different or larger than the first view of angle 150. The second digital camera 200 may be arranged such that to have a different or larger view of angle such as the first digital camera 130 may be placed at a front side of the electronic device 10 and the second digital camera 200 may be placed at a rear side (at the opposite side of the front side) of the electronic device 10. In this case, when the optical code 110 is provided to the first angle of view 150, the first digital camera 130 perceives the image of the optical code 110 and the electronic device 10 detects the optical code 110 and then activates the second digital camera 200 to capture a picture.

The electronic device 10 comprises a microprocessor 190 controlling both the first digital camera 130 and the second digital camera 200 and possibly further the non-volatile memory 230. The first digital camera 130 and the second digital camera 200 may be embedded and integrated to the electronic device 10.

The second digital camera 200 is operated automatically; however the second digital camera 200 may also be operated manually, i.e. the electronic device 10 may activate or adjust the second digital camera 200 to capture a picture and a user may trigger the electronic device 10 to take the picture.

The picture may be further processed by the microprocessor 190 such that a clickable region 170, 180 on the picture is defined, which comprises an image of an optical code at least partially, and a respective url is associated with the clickable region 170, 180 such that a web browser is directed to the respective url when the respective clickable region is clicked by a user.

The electronic device may optionally comprise other data capturing means 220 controllable by the microprocessor 190. Other data capturing means 220 may be triggered to capture data, when an optical code 110 is detected by the electronic device.

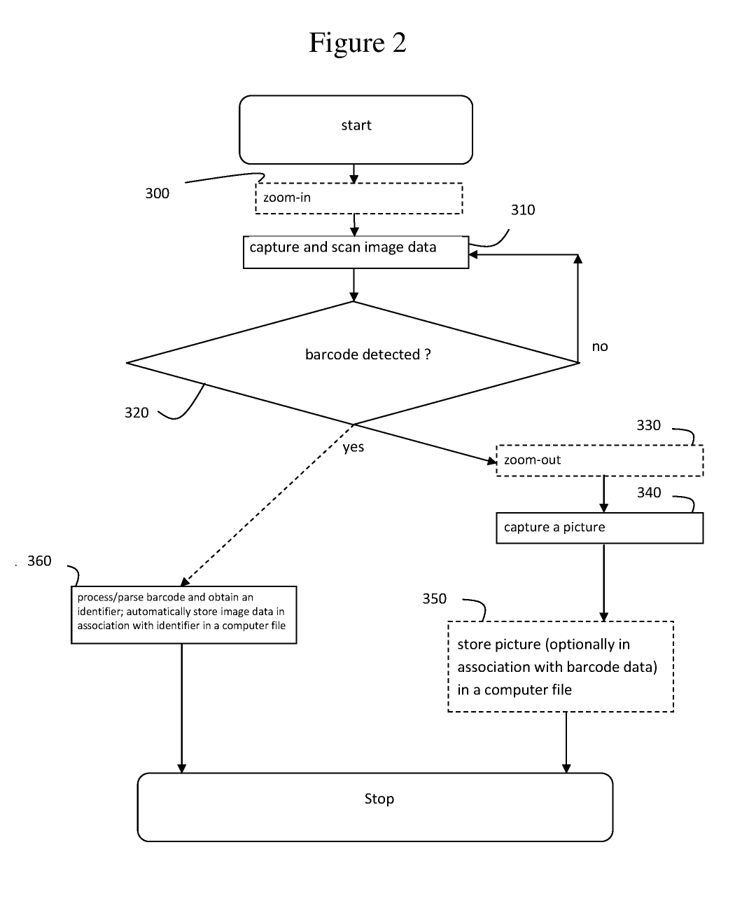

FIG. 2 shows a flowchart showing an exemplary embodiment of a computer program according to the invention. The method includes providing an electronic device 10 for digital image capturing with a digital camera system comprising a first digital camera 130 having a first angle of view 150, 160 adapted to capture image data; capturing image data 310 with the first digital camera 130 to detect an optical code 110; and then automatically activating 340 the first digital camera 130 to capture a picture, when an optical code 110 in the image data is detected 320. The method may include to zoom-in the zooming apparatus 240 before step 310 and/or to zoom-out the zooming apparatus 240 after the detection step 320.

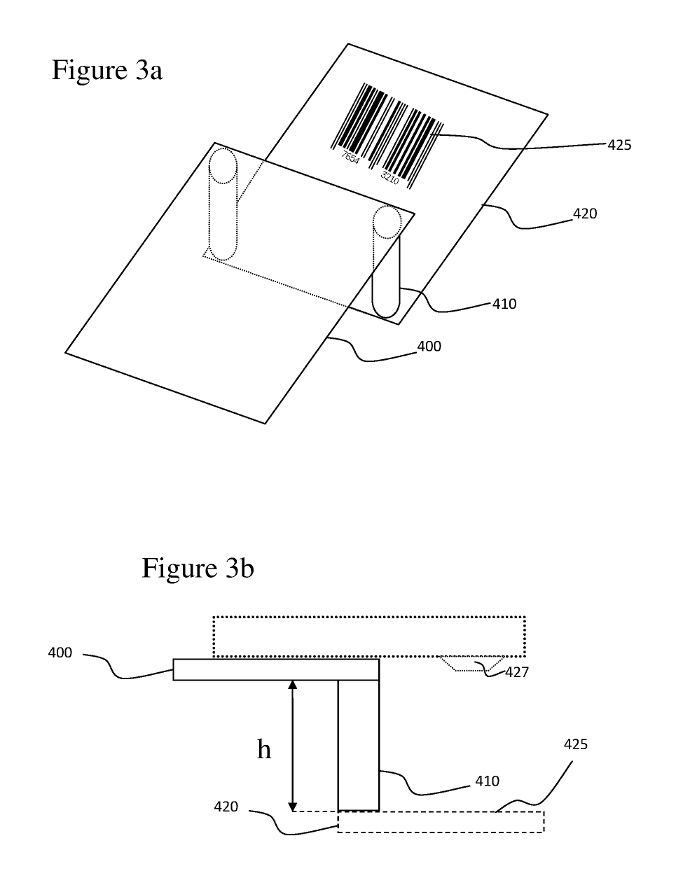

FIG. 3 shows an exemplary support device for an electronic device 10 for digital image capturing with a digital camera system comprising a digital camera 130, 427, comprising a docking body part 400 adapted to support a flat surface of the electronic device having the digital camera at a first side of the docking body part 400 and a protrusion 410 protruding from the docking body part 400 from a second side thereof opposite to the first side, such that when the electronic device 10 is placed on the docking body part 400 and a medium 100, 420 comprising an optical code 110, 425 is approached to the digital camera of the electronic device for scanning the optical code 110, 425, the medium 100, 420 is obstructed by the protrusion 410 keeping a predefined minimum distance h between the camera 130, 427 and the medium 100, 420. The protrusion 410 is arranged resizable to adapt the predefined minimum distance h to the electronic device 10 or medium 420.

The above description is not limiting. Many other embodiments or adaptations of the above embodiments/modifications without departing from the scope of the invention will be apparent to those skilled in the art upon reviewing the above description. Each of the following claims is incorporated herein to the specification by reference as a separate exemplary embodiment.

1.-23. (canceled)

24. A computer program for digital image capturing, configured, when executed by an electronic device having a digital camera system for digital image capturing comprising a first camera with a first angle of view and a second camera with a second angle of view:
to capture first image data with said first camera, to detect an optical code in said first image data, and to trigger said second camera to capture second image data, when an optical code in said first image data is detected.

25. The computer program according to claim 24, wherein said second angle of view is larger than said first angle of view.

26. The computer program according to claim 24, wherein said electronic device comprises a zooming means to change said first angle of view, said computer program further configured to activate said zooming means of said digital camera system to change said second angle of view, when an optical code in first image data is detected.

27. The computer program according to claim 24, wherein said electronic device comprises a transmitter adapted to transmit data to internet, said computer program further configured to send said second image data to an internet server via internet using said transmitter.

28. The computer program according to claim 24, wherein said electronic device comprises a digital non-volatile memory device, said computer program further configured to store said second image data automatically in said digital non-volatile memory device.

29. The computer program according to claim 24, wherein said electronic device comprises a zooming means to change said first angle of view, said computer program further configured to activate said zooming means of said digital camera system to zoom out to increase said second angle of view, when an optical code in first image data is detected, such that said optical code becomes smaller in said second image data.

30. The computer program according to claim 24, wherein said first digital camera is arranged at a front side of said electronic device and said second digital camera is arranged at a rear side of said electronic device opposite to said front side.

31. A computer program for digital image capturing, configured, when executed by an electronic device having a digital camera system for digital image capturing comprising a digital camera with a first angle of view adapted to capture first image data:
to capture first image data with said digital camera, to detect an optical code in said first image data; and when an optical code in first image data is detected: to increase said first angle of view and then to trigger said digital camera to capture second image data.

32. The computer program according to claim 31, wherein said electronic device comprises a zooming means to change said first angle of view, said computer program further configured to activate said zooming means of said digital camera system to increase said first angle of view, preferably by zooming out, when an optical code in first image data is detected, such that said optical code becomes smaller in said second image data.

33. The computer program according to claim 31, wherein said electronic device comprises a transmitter adapted to transmit data to internet, said computer program further configured to send said second image data to an internet server via internet using said transmitter.

34. The computer program according to claim 31, wherein said electronic device comprises a digital non-volatile memory device, said computer program further configured to store said second image data automatically in said digital non-volatile memory device.

35. An electronic device having a digital camera system for digital image capturing comprising a first camera with a first angle of view and a second camera with a second angle of view, wherein said electronic device is configured:
to capture first image data with said first camera to detect an optical code in said first angle of view;
to detect an optical code in said first image data; and
to trigger said second camera to capture second image data, when an optical code in said first image data is detected.

36. The electronic device according to claim 35, wherein said second angle of view is larger than said first angle of view.

37. The electronic device according to claim 35, wherein said electronic device comprises a zooming means to change said first angle of view, wherein said electronic device is further configured to activate said zooming means of said digital camera system to change said second angle of view, when an optical code in first image data is detected.

38. The electronic device according to claim 35, wherein said electronic device comprises a transmitter adapted to transmit data to internet, wherein said electronic device is further configured to send said second image data to an internet server via internet using said transmitter.

39. The electronic device according to claim 35, wherein said electronic device comprises a digital non-volatile memory device, wherein said electronic device is further configured to store said second image data automatically in said digital non-volatile memory device.

40. The electronic device according to claim 35, wherein said electronic device comprises a zooming means to change said first angle of view, wherein said electronic device is further configured to activate said zooming means of said digital camera system to zoom out to increase said second angle of view, when an optical code in first image data is detected, such that said optical code becomes smaller in said second image data.

41. The electronic device according to claim 35, wherein said first digital camera is arranged at a front side of said electronic device and said second digital camera is arranged at a rear side of said electronic device opposite to said front side.

42. The electronic device according to claim 35, wherein said first camera and said second camera are arranged such that said second angle of view comprises said first angle of view at least partially.
